(19) United States
(12) Patent Application Publication
(10) Pub. No.: US 2026/0084376 A1
(43) Pub. Date: Mar. 26, 2026

(54) 3D PRINTER WITH ADVANTAGEOUS IRRADIATION DEVICE, AND METHOD

(71) Applicant: Voxeljet AG, Friedberg (DE)

(72) Inventors: Bastian Heymel, Augsburg (DE); Christoph Scheck, Augsburg (DE); Melanie Weigel, Augsburg (DE)

(21) Appl. No.: 19/402,152

(22) Filed: Nov. 26, 2025

Related U.S. Application Data
(63) Continuation-in-part of application No. 17/777,410, now abandoned.

(30) Foreign Application Priority Data
Nov. 18, 2019 (DE) 10 2019 007 982.5

(51) Int. Cl. B29C 64/277; B29C 64/209; B29C 64/393; B33Y 10/00; B33Y 30/00; B33Y 50/02

(52) U.S. Cl. CPC B29C 64/277; B29C 64/209; B29C 64/393; B33Y 10/00; B33Y 30/00; B33Y 50/02

(57) ABSTRACT

The invention relates to a 3D printer having an advantageous irradiation device, and a method for 3D printing. The irradiation device is an array of multiple irradiation units each of which is individually controllable with regard to its temperature. According to an embodiment, a subset of irradiation units is combined to a group, each group of irradiation units being controllable with regard to its temperature. The target temperature of the irradiation units at the edges can be set to a temperature that is higher than the target temperature of the irradiation units in the remaining area.

### CLAIM OF PRIORITY

This application is a continuation patent application of U.S. patent application Ser. No. 17/777,410 which is a US national phase filing under 35 USC § 371 from PCT Patent Application serial number PCT/DE2020/000286 filed on Nov. 17, 2020 and claim priority therefrom. This application further claims priority to German Patent Application Number DE 102019007982.5 filed on Nov. 18, 2019. U.S. patent application Ser. No. 17/777,410, International Patent Application number PCT/DE2020/000286 and German Patent Application number DE 102019007982.5 are each incorporated herein by reference in its entirety.

### FIELD

The invention relates to a 3D printer with an advantageous irradiation device and method.

European Patent EP 0 431 924 B1 describes a process for producing three-dimensional objects based on computer data. In the process, a thin layer of particle material is deposited on a platform by means of a recoater and has a binder material selectively printed thereon by means of a print head. The particulate region with the binder printed thereon bonds and solidifies under the influence of the binder and, optionally, an additional hardener. Next, the build platform is lowered by one layer thickness or the recoater/print head unit is raised and a new layer of particle material is applied, the latter also being printed on selectively as described above. These steps are repeated until the desired height of the object is achieved. Thus, the printed and solidified regions form a three-dimensional object (3D part, molding).

Upon completion, the object made of solidified particle material is embedded in loose particle material, from which it is subsequently freed. For this purpose a suction device may be used, for example. This leaves the desired objects which are then further cleaned of any residual powder, e.g. by brushing it off.

Other powder-based rapid prototyping processes, e.g. selective laser sintering or electron beam sintering, work in a similar manner, also applying loose particle material layer by layer and selectively solidifying it using a controlled physical source of radiation.

In the following, all these processes will be summarized by the term “three-dimensional printing method” or “3D printing method”.

According to the prior art, panel-type infrared heaters are widely used to heat an object surface as evenly and in as controlled a manner as possible. This process is often used for drying printed surfaces, pre-tempering or thermoforming plastics. Most plastics absorb long- and medium-wave infrared electromagnetic radiation between 2 μm and 10 μm very well, so ceramic irradiation units or quartz cassette-style irradiation units are often used in addition to short-wave irradiation unit tubes. All these irradiation units have in common that they work according to the same physical principle: A current-carrying conductor heats up due to its resistance and, due to its temperature, emits a spectrum of electromagnetic radiation usually approximating Planck's spectrum. The conductors used are all so-called cold conductors, which have a positive temperature coefficient, which is why they are also known as PTC (Positive Temperature Coefficient) conductors. As a result, their ohmic resistance increases with an increase in temperature, which initially leads to higher heat generation when a voltage is applied. The resistivity p initially increases linearly with the temperature T in

$$ρ ( T ) = {ρ}_{0} [ 1 + {α}_{0} ( T - {T}_{0} ) ]$$

where ρ₀ is the resistivity and α₀ is the temperature coefficient at the reference temperature T₀.

However, an ever increasing resistance leads to a limitation of the maximum current, so that a certain temperature is reached at a defined applied voltage in each case. The reason for this is that the linear range of validity of the approximation described above is left, since the following generally applies:

$$ρ ( T ) = {ρ}_{0} {e}^{α ( T - {T}_{0} )}$$

Said temperature is thus dependent on the temperature coefficient of the material used, the resistivity ρ(T), the length of the heating conductor l and the cross-sectional area A of the latter. By applying a defined voltage U, the heating power P of such an irradiation unit can thus be controlled, since the following applies

$$P = \frac{{U}^{2}}{R} with R = ρ ( T ) \cdot \frac{l}{A}$$

This type of pre-tempering is also used in additive manufacturing processes to achieve a temperature on the build field within the sintering window of the particle material used, especially in sintering processes.

In exemplary prior art embodiments, multiple infrared irradiation units are combined into a single assembly to cover the largest possible areas for high productivity. In order not to overheat the object surface, an infrared pyrometer can be used to measure the surface temperature as an input variable for a heating control. In most cases, the power of all infrared irradiation units is controlled by controlling the voltage of a single channel. As a result, the heat output of all irradiation units is controlled by the same value. However, this leads to varying temperatures on the irradiated surface due to geometric conditions such as the distance from the irradiation assembly to the object surface. Especially at the edges of the irradiated build field, the optimum operating temperature for a 3D printing process is no longer reached there.

Furthermore, ceramic as well as quartz irradiation units exhibit strong fluctuations in the emitted radiation intensity. The reason for this, apart from the large manufacturing tolerances, is the direct dependence of the achieved irradiation unit temperature on the thickness, length and exact composition of the heating conductor. In addition, ceramic irradiation units in particular have large variations in the thickness of the ceramic material enveloping the heating conductors, which leads to reduced emission of electromagnetic radiation due to the low thermal conductivity compared to metals. Instead, the heating power produced is dissipated via the electrical supply of the heating conductors and dissipation of the heat to the mounting points of the irradiation unit.

This leads to considerable disadvantages in 3D printing processes and especially in sintering processes. Since distortion occurs due to volume shrinkage during solidification of the previously sintered molded articles, it is not possible to produce moldings in the peripheral areas of the build field. Thus, the production efficiency of such a device is limited. However, temperature fluctuations are not exclusively limited to the peripheral areas. During production, the resulting mechanical variables also vary, as does the aging of the particle material used. With a larger surface area of the build field, these effects increase.

Another disadvantage of medium and longer spectrum infrared irradiation units is their slow response time, usually quoted by manufacturers in the order of minutes. Thus, it may well take more than 60 sec. for the irradiation unit used to reach its operating temperature and emit infrared radiation of the desired spectrum and intensity. This is a major disadvantage in 3D printing processes. In 3D sintering processes, the times for one layer construction cycle are usually below the reaction time of the known long-wave panel-type irradiation units. Thus, temperature fluctuations during the printing process often cannot be compensated in time with long-wave irradiation units.

It is therefore an object of the present invention to provide an irradiation device using which a uniform temperature can be achieved on the build field and/or temperature control can be achieved more quickly than in known printing processes, or at least the disadvantages of the prior art can be reduced or avoided altogether.

### BRIEF SUMMARY OF THE DISCLOSURE

In one aspect, the disclosure relates to an irradiation device suitable for a 3D printer, the irradiation device being characterized by being an array of multiple irradiation units, each of which is individually controllable with regard to its temperature, or a subset of irradiation units being combined to a group, each group of irradiation units being controllable with regard to its temperature.

In another aspect, the disclosure relates to a method of manufacturing a molding by means of particle material deposition and selective solidification, said method using an irradiation device according to the disclosure, wherein the target temperature setting in the irradiation device is set to a higher target temperature in the irradiation units at the edges compared to the remaining areas of the irradiation device.

### BRIEF DESCRIPTION OF THE DRAWINGS

Figure H1 shows a prior art panel heater.

Figure H2 shows an panel-type infrared heater with temporal and local control and the resulting surface temperature.

Figure H3 shows an irradiation device according to the disclosure with an arrangement of measuring instruments drawn by way of example.

Figure H4 shows an exemplary irradiation device according to the disclosure with an arrangement of groups of infrared irradiation units, which are combined into individual heating circuits.

Fig. H5 schematically shows an exemplary embodiment of irradiation units in an irradiation device according to the disclosure with control.

### DETAILED DESCRIPTION OF THE DISCLOSURE

The object underlying the application is achieved by an irradiation device suitable for a 3D printer, the irradiation device being characterized by being an array of multiple irradiation units, each of which is individually controllable with regard to its temperature, or a subset of irradiation units being combined to a group, each group of irradiation units being controllable with regard to its temperature, as well as by a 3D printing method using such an irradiation device.

In the following, several terms will be defined more precisely. Otherwise, the terms used shall have the meanings known to the person skilled in the art.

In the sense of the disclosure, “layer construction methods” or “3D printing methods” or “3D methods” or “3D printing”, respectively, are all methods known from the prior art which enable the construction of parts in three-dimensional shapes and are compatible with the process components and devices further described herein.

As used in the disclosure, “binder jetting” means that powder is applied in layers onto a build platform, one or more liquids is/are printed on the cross-sections of the part on this powder layer, the position of the build platform is changed by one layer thickness with respect to the previous position, and these steps are repeated until the part is finished. In this context, binder jetting also refers to layer construction methods that require a further process component such as layer-by-layer exposure, e.g. with IR or UV radiation.

In the “high-speed sintering process” as defined in the disclosure, a thin layer of plastic granules, such as PA12 or TPU, is applied to a build platform (build field), which is preferably heated. Next, an inkjet print head moves over a large area of the platform and wets the areas of the build field with infrared light-absorbing ink (IR absorber. IR acceptor) where the prototype is to be created. The build platform is then irradiated with infrared light. The wetted areas absorb the heat, causing sintering of the underlying powder layer. However, the unprinted powder remains loose After sintering, the build platform is lowered by one layer thickness. This process is repeated until the construction of a part is completed. The sintered parts are then cooled in a controlled manner in the build area before they can be removed and unpacked. It may also be advantageous in this regard to use an overhead lamp or an irradiation assembly in addition to a sintering lamp, which use different wavelength spectra with substantially no overlap in wavelength spectrum. In one variation, a so-called detailing agent can be printed in addition to the IR absorber, which serves to cool the areas printed with it. One variant of the high-speed sintering process is also known as the fusion jet process, wherein the print head injects a heat-conducting fluid (often referred to as a “fusing agent.” which corresponds to the absorber) onto a layer of the particle material. Immediately after printing, a heat source (infrared light) is applied. The areas to which the fusing agent has been applied are heated more strongly than the powder without this liquid. Thus, the required areas are fused. Another additive is then used, also known as a detailing agent, which is used for insulation. This selective impression occurs around the areas on which the fusing agent or absorber has been printed. Said additive is intended to promote sharp edge formation. This aim is to be achieved by making the temperature differences between printed and unused powder more significant. A process using these two printing liquids can also be referred to as a multi-jet fusion process.

A “3D shaped article”, “molded article” or “part” in the sense of the disclosure means any three-dimensional object manufactured by means of the method according to the invention or/and the apparatus according to the invention and exhibiting dimensional stability.

“Build area” is the geometric location where the particle material bed grows during the manufacturing process by repeated coating with particle material or through which the bed passes when applying continuous principles. The build area is generally bounded by a bottom, i.e. the build platform, by walls and an open top surface, i.e. the build plane. In continuous principles, there usually are a conveyor belt and limiting side walls. The build area can also be designed in the form of what is called a job box, which constitutes a unit that can be moved in and out of the apparatus and allows batch production, with one job box being moved out after completion of a process to allow a new job box to be moved into the apparatus immediately, thereby increasing both the production volume and, consequently, the performance of the apparatus.

As the “construction material” or “particle material” or “powder” or “powder bed” in the sense of the disclosure, all flowable materials known for 3D printing may be used, in particular in the form of a powder, slurry or liquid. These may include, for example, sands, ceramic powders, glass powders and other powders of inorganic or organic materials, such as metal powders, plastic materials, wood particles, fiber materials, celluloses or/and lactose powders, as well as other types of organic, pulverulent materials. The particle material is preferably a free-flowing powder when dry, but a cohesive, cut-resistant powder may also be used. This cohesiveness may also result from adding a binder material or an auxiliary material, e.g. a liquid. The addition of a liquid can result in the particle material being free flowing in the form of a slurry. In general, particle materials may also be referred to as fluids in the sense of the disclosure.

In the present application, particle material and powder are used synonymously.

The “particle material application” is the process of generating a defined layer of powder. This may be done either on the build platform (build field) or on an inclined plane relative to a conveyor belt in continuous principles. The particle material application will also be referred to below as “recoating”.

“Selective liquid application” or “selective binder application” in the sense of the disclosure may be effected after each particle material application or irregularly, depending on the requirements for the molded article and for optimization of the molded article production, e.g. several times with respect to particle material application. In this case, a sectional image of the desired article is printed.

The “apparatus” used for carrying out a method according to the disclosure may be any known 3D printer which includes the required parts. Common components include recoater, build field, means for moving the build field or other parts in continuous processes, job box, metering device and heating and irradiating means and other parts which are known to the person skilled in the art and will therefore not be described in detail herein.

The construction material according to the disclosure is always applied in a “defined layer” or “layer thickness”, which is individually adjusted according to the construction material and the process conditions. It is, for example, 0.05 to 0.5 mm, preferably 0.06 to 0.2 mm or 0.06 to 0.15 mm, particularly preferably 0.06 to 0.09 mm.

A “recoater” within the meaning of the disclosure is an apparatus part that can receive fluid, e.g., particle material such as mineral, metallic or plastic materials, wood in the form of particles, or mixtures thereof, and dispense or apply it layerwise in a controlled manner onto a build platform of a 3D apparatus. The recoater can be elongated and the particle material is located in a reservoir above an outlet opening. However, the recoater may also consist of a stationary blade or a counter-rotating roller, each spreading a specific quantity of powder on the build field in front of the blade or roller.

A “coating blade” as defined in the disclosure is a substantially flat part made of metal or other suitable material, which is located at the outlet opening of the recoater and through which the fluid is discharged onto the build platform and is smoothed down. A recoater may have one or two or more coating blades. A coating blade can be an oscillating blade that performs oscillations in the sense of a rotary motion when excited. Further, this oscillation can be switched on and off by a means for generating oscillations. Depending on the arrangement of the outlet opening, the coating blade is arranged “substantially horizontally” or “substantially vertically” within the meaning of the disclosure.

“Irradiation assembly” as used in the disclosure means an arrangement of irradiation devices.

An “irradiation device” as used in the disclosure means a device that emits light of a particular spectrum and comprises a plurality of irradiation units, each of which is individually adjustable with regard to its temperature and optionally controllable. The “irradiation device” as used in the disclosure may also be referred to as
an “overhead lamp” or “overhead irradiation unit” or “irradiation assembly” or “emitter unit” or “radiation unit” or “heating radiator” or “build field heater” as used in the disclosure is a source of radiation that is mounted above the build field and forms a functional unit. The wavelength of the emitted electromagnetic radiation is stationary and its radiant flux can be regulated. The irradiation device is a functional unit that emits electromagnetic radiation of a specific spectrum. It may contain individual irradiation units or a large number of irradiation units, which can be controlled individually or combined in groups. Optionally, it covers substantially the entire build field and is mounted at a position in the apparatus, or it is smaller than the build field and may be movable across the build field.

A “peripheral area” as used in the disclosure means the area of an irradiation assembly that is located at the edge of the irradiation assembly and can be delineated from the interior area. In this case, the peripheral area and the interior area form the total area of the irradiation assembly in terms of its surface on which the irradiation devices are mounted.

“Interior area” as used in the disclosure means the area of an irradiation assembly that is inside the irradiation assembly and can be delineated from the peripheral area.

“3D printer” or “printer” as used in the disclosure means the apparatus in which a 3D printing method can take place. A 3D printer in the sense of the disclosure comprises a means for applying construction material, e.g. a fluid such as a particle material, and a solidification unit, e.g. a print head or an energy input means such as a laser or a heat lamp. Other machine components known to the person skilled in the art and components known in 3D printing are combined with the above-mentioned machine components in individual cases, depending on the specific requirements.

A “build field” is the plane or, in a broader sense, the geometric location on or in which a particle material bed grows during the construction process by repeated coating with particle material. The build field is frequently bounded by a bottom, i.e. the “build platform”, by walls and an open top surface, i.e. the build plane.

The process of “printing” or “3D printing” in the sense of the disclosure summarizes the operations of material application, selective solidification or imprinting and working height adjustment and takes place in an open or closed process chamber.

A “receiving plane” in the sense of the disclosure means the plane onto which the construction material is applied. In accordance with the disclosure, the receiving plane is always freely accessible in one spatial direction by a linear movement.

“Build field tool” or “functional unit” in the sense of the disclosure refers to any means or device part used for fluid application, e.g. particle material, and selective solidification in the production of moldings. Thus, all material application means and layer treatment means are also build field tools or functional units.

According to the disclosure, “spreading out” or “application” means any manner in which the particle material is distributed. For example, a larger quantity of powder may be placed at the starting position of a coating pass and may be distributed or spread out into the layer volume by a blade or a rotating roller.

“Recoater” or “material application means” as used in the disclosure refers to the unit by means of which a fluid is applied onto the build field. The unit may consist of a fluid reservoir and a fluid application unit. According to the present invention, the fluid application unit comprises a fluid outlet and a “coating knife device”. Said coating knife device may be a coating blade. However, any other conceivable, suitable coating knife device may be used. For example, rotating rollers or a nozzle are conceivable as well. Material can be fed via reservoirs in a free-flowing manner or by means of extruder screws, pressurisation or other material conveying devices.

“Warping” refers to the bending up of printed layers due to shrinkage occurring at different times as the bonded particles solidify. This may lead to coating errors when structures rise from the build field plane due to warping and are possibly carried away by the recoater during the next coating operation.

The “print head” or means for selective solidification in the sense of the disclosure usually consists of various components. Among other things, these can be printing modules. The printing modules have a large number of nozzles from which the “binder” is ejected as droplets onto the build field in a controlled manner. The printing modules are aligned with respect to the print head. The print head is aligned with respect to the machine. This allows the position of a nozzle to be assigned to the machine coordinate system. The plane in which the nozzles are located is usually referred to as the nozzle plate. Another means of selective solidification can also be one or more lasers or other radiation sources or a heat lamp. Arrays of such radiation sources, such as laser diode arrays, can also be considered. It is permissible in the sense of the disclosure to implement selectivity separately from the solidification reaction. Thus, a print head or one or more lasers can be used to selectively treat the layer, and other layer treatment means can be used to start the solidification process. In one embodiment, an IR absorber is printed on the particle material, followed by solidification using an infrared source.

“Layer treatment means” in the sense of the disclosure refers to any means suitable for achieving a certain effect in the layer. This may be the aforementioned units such as print heads or lasers, but also heat sources in the form of IR irradiation units or other radiation sources such as UV irradiation units, for example. Means for deionisation or ionisation of the layer are also conceivable. What all layer treatment means have in common is that their zone of action is distributed linearly over the layer and that, like the other layering units such as the print head or recoater, they must be guided over the build field to reach the entire layer.

As used in the disclosure, the “feed container” or “preheating container” is a vessel that contains particle material and delivers an amount thereof to the recoater after each layer or after any number of layers. For this purpose, the feed container can advantageously extend over the entire width of a recoater. The feed container has a closure at the lower end that prevents the particle material from escaping unintentionally. The closure can be designed, for example, as a rotary feeder, a simple slider or other suitable mechanisms according to the prior art. A feed container as defined in the disclosure may contain particle material for more than one layer. Preferably, the feed container even contains particle material for the application of 20 or more layers. The particle material comes either via a conveyor line from a larger supply in the form of a silo or a big bag or is filled manually into the container. Filling is preferably performed through an opening at the top edge. This allows the particle material to be conveyed in the feed container by gravity, thus eliminating the need for additional conveyors in the container. The feed container may also have vibration mechanisms to prevent bridging of the particle material in the container. The feed container has an area that receives the particle material, typically located between the sidewalls and the closure. According to the disclosure, it is advantageous for a heating means to be arranged in the area that receives the particle material. The heating means is arranged so that the particle material flows around the heating means, thus improving the heating of the particle material. The feed container may be stationary, in which case it can be located, for example, above the holding position of the recoater or above the build field. Refilling can then be carried out as required or/and controlled by the volume quantity with pre-tempered particle material by moving the recoater at or below the feed container. However, the feed container may also be detachably or non-detachably connected to the recoater. It may also be advantageous for design or/and cost reasons that the recoater is not heatable. The recoater may then have passive insulation. However, the recoater may also not be heated at all, nor provided with insulation, if the preheated particle material is delivered to the recoater in a volume substantially equal to, or 1.2 to 2 times, a layer volume, allowing it to be applied to the build field with virtually no residence time in the recoater and thus with substantially no heat loss.

### DETAILED DESCRIPTION OF THE DISCLOSURE

The various aspects and advantageous embodiments of the disclosure will be described in more detail below.

The object underlying the application is achieved by an irradiation assembly suitable for a 3D printer, the irradiation assembly being characterized in that it is an array of several irradiation units, each of which is individually controllable with regard to its temperature, or a subset of irradiation units being combined to a group, each group of irradiation units being controllable with regard to its temperature.

The object underlying the application is further achieved by a method for producing a molding by means of particle material application and selective consolidation, said method using an irradiation assembly according to the disclosure, wherein the target temperature setting of the irradiation assembly in the irradiation units at the edges is set to a higher target temperature compared to the other areas of the irradiation assembly.

It has been shown that a temperature control at the irradiation assembly itself by a temperature control circuit, in contrast to a power control via the adjustment of the wattage, allows better adjustment of the build field temperature and thus also faster adjustment of temperature deviations on the build field can be achieved. In this way, a more uniform temperature distribution on the build field and in particular at the peripheral areas of the build field is advantageously achieved as well.

Furthermore, temperature control is advantageously independent of fluctuations in the voltage supply, manufacturing and assembly tolerances and other external influences such as ambient temperature, humidity and convective heat conduction.

This also minimizes feedback effects, e.g. caused by absorption of secondary radiation during layer construction.

Preferred embodiments are disclosed in the subclaims.

A preferred irradiation assembly according to the disclosure is characterized in that a target temperature is set at each irradiation unit or group of irradiation units, with the proviso that the power (watts) of the irradiation unit is not set as a target parameter.

A preferred irradiation assembly according to the disclosure is characterized in that substantially each irradiation unit or group of irradiation units in the irradiation assembly is set to a different target temperature.

A preferred irradiation assembly according to the disclosure is characterized in that the irradiation assembly comprises a control circuit for target temperature adjustment of each irradiation unit or/and for target temperature adjustment on the build field.

A preferred irradiation assembly according to the disclosure is characterized in that the irradiation assembly uses an algorithm to achieve a target temperature on the build field by means of target temperature setting in the irradiation assembly or/and wherein the target temperature setting is achieved by defining irradiation units as a subset of irradiation units combined to a group.

A preferred irradiation assembly according to the disclosure is characterized in that the irradiation assembly comprises at least one thermographic camera directed at the build field and/or at least one infrared pyrometer and/or at least one temperature sensor, wherein the temperature sensor is preferably a thermocouple or a resistance thermometer.

A preferred irradiation assembly according to the disclosure is characterized in that the thermographic camera is used for local measurement recordings and the infrared pyrometer is used for calibration of the absolute temperature values.

In another aspect, the disclosure relates to a 3D printer comprising an irradiation assembly according to the disclosure, wherein a target temperature on the build field is adjustable by a target temperature setting of each irradiation unit in the irradiation assembly.

In another aspect, the disclosure relates to a method of manufacturing a molding by means of particle material application and selective solidification, the method using an irradiation assembly according to the disclosure, wherein the target temperature setting in the irradiation assembly is set to a higher target temperature in the irradiation units at the edges compared to the remaining areas of the irradiation assembly.

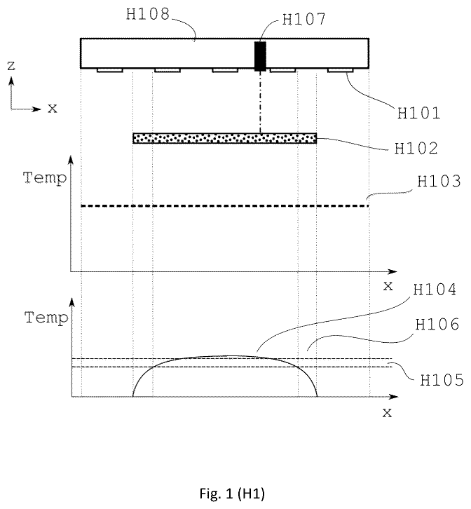

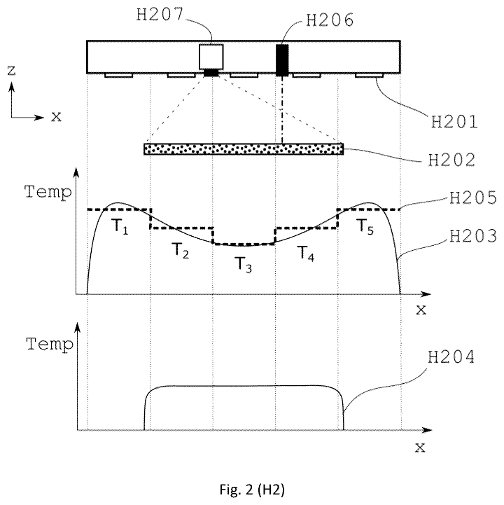

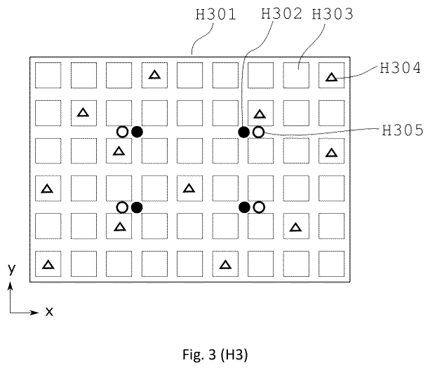

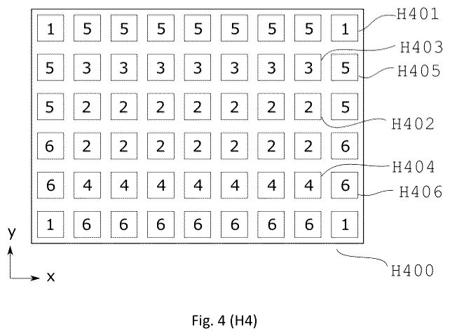

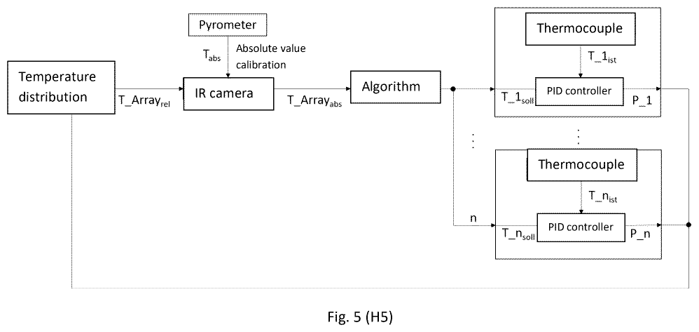

A preferred method according to the disclosure is characterized in that the target temperature in a cross-section of the irradiation assembly corresponds to the distribution shown in FIG. 2.

A preferred method according to the disclosure is characterized in that the method is a 3D high-speed sintering process or a 3D sintering process.

A preferred method according to the disclosure is characterized in that the arrangement and/or target temperature of the irradiation units is derived from the physical laws of heat transfer and finite element method calculations with the development of a proprietary algorithm.

In the apparatus and method according to the disclosure, it may be further preferred that a feed container is included or used in the apparatus.

### FURTHER EXEMPLARY DESCRIPTION OF THE DISCLOSURE

Various aspects of the disclosure will be described below by way of example and should not be construed as restrictive. Also, any aspect of the exemplary Figures shown below can be made usable in any combination.

An attempt will be made to compensate for the above-described disadvantages of known irradiation devices and their use in 3D printing processes and to take this into account by placing moldings to be created in a specific arrangement in the build area. In addition, certain geometries are difficult to create through the sintering process or can only be created in certain spatial orientations. This stands in the way of automated, cost-reduced production and is one of the reasons for the comparatively high cost of sintered moldings.

To circumvent these limitations, an attempt is first made to compensate for the inhomogeneous temperature distribution on the object surface H₂O₂ by means of different irradiation unit powers, as shown in FIG. 2. In this case, individual infrared irradiation units H201 at the peripheral areas of the irradiation assembly are combined to form dedicated heating circuits, which are operated at a higher power compared to those in the center of the assembly. In this example, 5 different surface temperatures H205 of the panel-type infrared irradiation units H201 are outlined. The surface temperatures are approximated as closely as possible to the location-dependent heating curve H205 previously calculated from geometric and physical considerations. The result is a relatively homogeneous temperature field H204 on the object surface. For a control of the resulting temperatures, an infrared pyrometer H206 is used again, but this time coupled with a thermographic camera H207, which is able to record the temperature distribution of the object surface with spatial resolution.

The measurement data from the thermographic camera can now be used to control the individual panel-type irradiation units in a targeted manner and thus compensate for non-uniformity in the local constancy of the object surface temperatures, which includes their peripheral areas in particular. Each individual irradiation unit is assigned a corresponding area element on the object surface. In one embodiment, the infrared pyrometer is used for absolute value correction, thus guaranteeing that a temperature drift is prevented in the measurements of the thermographic camera and ensuring temporal constancy of the temperature field.

As in the assembly (H301) of individual irradiation units (H303) shown in Fig. H3, control by thermographic camera (H302) and infrared pyrometer (H305) does not simply adjust the power at the individual heating elements. Instead, the temperature of the individual heating elements is measured by means of a temperature sensor (H304), which is integrated into the heating elements, and fed to a control system as a measured value. If the control system is designed as a PID controller, it can be used to minimize the time required for the irradiation units to reach the target temperature. The prerequisite for this is that sufficient reserve has been given to the heating power of the individual heating elements. For example, an irradiation unit can be used whose maximum power is 650 watts, but the temperature of the irradiation unit to be reached at equilibrium is already reached at 200 watts. The controller is then able to maximize the set power until the target temperature is reached, only to reduce it back to the steady-state condition within a short period of time when the target temperature is reached. The response time can thus be reduced to well below 20 sec, which is within the layer cycle time of a sinter printer. Thus, it is now possible for the system to react in time to temperature fluctuations.

Furthermore, this method can greatly reduce the lengthy heating time until the steady state is reached to as little as a quarter.

In an exemplary arrangement of an irradiation assembly there are 4 thermographic cameras H302 and infrared pyrometers H305 each, in order to enable contactless object surface temperature measurements with the smallest possible angular error and to keep the distance between the assembly and the object surface small. A smaller distance results in higher energy efficiency. H304 are conventional temperature sensors, e.g. thermocouples or resistance thermometers, which continuously measure the surface temperature of the infrared irradiation units, and due to the Stefan-Boltzmann law therefore the radiated power, and together with the other two measuring devices give the input values for the setpoint control. The target temperature of the individual heating elements is calculated using the following relationship:

$${\dot{Q}}_{12} = {C}_{12} \cdot ( {T}_{1}^{4} - {T}_{2}^{4} )$$

$${C}_{12} = {ε}_{1} \cdot {ε}_{2} \cdot {F}_{12}$$

The heat flow \dot{Q}₁₂ between the irradiation unit and the corresponding build field element with temperature T₁ is to be minimized by adjusting its temperature T₂. In addition to the emission factors of the irradiation unit ε₂ and the particle material on the build field ε₁, the so-called view factors F₁₂ and F₂₁ are decisive here. The view factors describe the orientation of both surfaces with respect to each other, where F₂₁ denotes the radiation flux from the irradiation unit to the build field and F₁₂ denotes the reverse path. The solution to finding the target temperatures for each heating element can be achieved by solving the system of resulting differential equations using the finite element method.

If a larger surface is to be covered, several irradiation unit fields can be staggered, i.e. arranged in combination, without any problems. By overlapping the measurement ranges of thermographic cameras and infrared pyrometers, calibration data can further be generated and thus the measurement accuracy of the instruments used can be improved by comparing the measurement data obtained. Thus, almost any build field geometries and sizes are possible without including another complex and cost-intensive design step.

Based on symmetry considerations, in one embodiment according to the disclosure, as shown in Fig. H4, groups of irradiation units of the irradiation assembly (H400) can be formed, i.e. (H401) to (H406), each of which can be controlled together. Thus, effort and costs can be saved without major restrictions in the temperature constancy on the object surface and the control algorithm is simpler. Hence, it makes sense to consider irradiation units (H401) separately at the 2nd order discontinuities, the corners of the object surface to be heated, since a stronger heat flow can be expected there due to the cooler environment. The situation is similar, when considering the edges (H405) and (H406) of the object surface to be heated, which are separated in order to compensate for differences between the front and back of the apparatus. (H203) and (H204) perform this for the interior area. The center of maximum symmetry in the middle of the assembly is then covered by (H402). Combining several individual irradiation units can also have a beneficial effect on measurement accuracy. For example, several temperature sensors can be evaluated within a group, using averaging to level out manufacturing tolerances.

Furthermore, Fig. H5 schematically shows an embodiment of a corresponding control as it can be applied in the embodiment examples shown in Fig. H3 and Fig. H4. Variations in the temperature distribution on the object surface are measured by means of a thermographic camera. An area element is also covered by an infrared pyrometer. The temperatures of this area element measured by the thermographic camera are averaged and compared with the value measured by the pyrometer. The camera is then readjusted until these two values are equal. Subsequently, the obtained correction factor is applied to the rest of the measured data. The corrected data is then transferred to the control systems of the heating elements via an algorithm. The algorithm has the task of assigning a corresponding area element to each individual irradiation unit. In addition, the overlap of the area elements is taken into account here. The reason for this is that the single irradiation unit also reaches adjacent area elements due to the radiation cone formed. In addition, the algorithm must take into account the geometric arrangement of the individual irradiation units, because adjacent irradiation units influence each other. In the worst case, this could lead to an unwanted oscillation of the outputs of the individual heating circuits over time.

The algorithm calculates target temperatures of the individual heating elements and sends them to the controllers of each heating circuit. The controllers, exemplified by conventional PID controllers, compare target temperature values and actual temperature values and ensure that the specified target temperature of the infrared irradiation units is reached in as little time and with as little deviation as possible by controlling the electrical power supplied to these irradiation units.

Next, the temperature distribution is measured again, and the process starts anew. Preferably, one cycle run of the entire control system takes place at a defined time per layer cycle of the construction process, so that the measurement is not impeded by units such as sintering device, recoater and print head, which move over the build field surface during this time.

Fig. H5 schematically shows an embodiment of a control according to the disclosure, wherein variations in the temperature distribution on the object surface are measured by means of a thermographic camera and temporal variations are compensated for by means of an infrared pyrometer, and the absolute temperature value can be calibrated. The obtained measurement data are fed to an algorithm that uses them to calculate the target temperatures of each infrared irradiation unit and passes them on to the PID controllers.

Furthermore, Figure H5 schematically shows an embodiment of a corresponding control as it can be applied in the embodiment examples in Fig. H3 and Fig. H4.

The solver algorithm, which has the task of calculating the target temperatures of the individual heating elements, does this on the basis of physical relationships that describe the heat flow. The view factors Fᵢⱼ represent an important component here.

The view factors describe the orientation of both surfaces with respect to each other, where F₂₁ denotes the radiation flux from the irradiation unit to the build field and F₁₂ denotes the reverse path. The view factors of two opposing finite surfaces have the general form

$${F}_{ij} = \frac{1}{{A}_{i}} {\int }_{{A}_{i}} {\int }_{{A}_{j}} \frac{cos {θ}_{i} cos {θ}_{j}}{π {R}_{ij}^{2}} {dA}_{i} {dA}_{j}$$

The view factor Fᵢⱼ is thus defined by the opposing finite surfaces Aᵢ and Aⱼ of the irradiation unit and the build field, respectively, as well as their respective angles to the unit normals to these, cos Θᵢ and cos Θⱼ, and the distance of the surfaces to each other, Rᵢⱼ.

In this regard, an irradiation device according to the disclosure may be designed in such a way that an irradiation unit illuminates not only an area element, i.e., an area (partial area) of the build field, but the entire build field. Thereby, the main radiation is projected onto a core area (area element) and furthermore, radiation also impinges around this core area. Likewise, each area element of the entire build field exchanges radiation with the irradiation unit or the irradiation assembly. This now applies to each individual irradiation unit in the irradiation device. The geometrical arrangement of irradiation units, such as their size, distance to the build field and distance to each other, is described by means of the above-mentioned view factors, as is the geometry of the build field to be heated, i.e. its orientation, length and width.

Since it is known which materials are used, their mostly temperature-dependent emissivity can be taken into account during design and operation, i.e. when performing a 3D printing process.

In addition, heat flows due to convection and heat conduction in the particle material and in the irradiation assembly, which in turn are temperature dependent, are included in the calculation in the design and operation of an irradiation assembly according to the disclosure. This applies in particular to the peripheral areas of the build field and the irradiation assembly, since convection and heat conduction occur more frequently here due to the discontinuity. Furthermore, additional heat conduction can be considered due to the location of the irradiation assembly and the coolants required for shielding from the machine housing.

Thus, a complex set of dependent inhomogeneous differential equations results. The task of a solver algorithm is now to solve this system of equations by determining the eigenvalues of the temperatures assigned to the heating radiators on the basis of the input of the measured temperature values in such a way that the calculated total heat flow \dot{Q}_{ges} between the irradiation units and the build field is minimized by including the build field target temperature.

The solution of these target temperatures (T_n,soll) for each irradiation unit n can be achieved by solving the system of equations by means of a solver using the finite element method. Such a solver can complete the calculations within the time of one layer cycle due to advances in the computing power of modern computer systems and optimizations in the individual calculation steps.

The target values calculated for the individual irradiation units are now transferred to a set of controllers, which have the task of setting these target temperatures at the irradiation units in the shortest possible time.

The controllers, exemplarily designed as conventional PID controllers, compare the target temperature value and the actual temperature value (T_n,ist) and ensure that the specified target temperature of the irradiation units (e.g. infrared irradiation units) is reached in the shortest possible time and with the smallest possible deviation by controlling the electrical power (P_n) supplied to these irradiation units via the variation of the applied average voltage.

Once the target temperature has been reached at the irradiation units, the temperature distribution is then measured again. By comparing the measured values with the calculated values, correction factors are now derived which will be included in future calculations. Thus, the system is able to respond dynamically to manufacturing tolerances in the structure and to disturbances, such as a change in the environmental condition or changes in the composition of the particle material, for example due to aging of portions of recycled material added to the printing process. Aging phenomena of the apparatus itself are also automatically corrected. A run-in of the 3D printer over several weeks as usual in the prior art is also avoided.

Preferably, one cycle run of the entire control system takes place at a defined time per layer cycle of the building process, so that the measurement is not impeded by units such as the sintering device, recoater and print head, which move over the build field surface during this time. Changes in the interaction with the radiation field or changes in the temperature of the units used in the layering process no longer have an effect, since the shadowing of the build field can be masked out in terms of time and location.

This has the advantage that, in contrast to the prior art, no adjustment or/and calibration of the apparatus is necessary. Furthermore, the 3D printer is capable of stable operation even under fluctuating environmental conditions, which thus includes operation in areas with higher or lower ambient temperatures. This leads to a cost advantage, as it eliminates costs for e.g. air conditioning of the environment.

During the printing process, the sintering process of the particle material surfaces wetted with IR acceptor (IR absorber), which correspond to the cross-section of a molded article to be produced, introduces additional energy by means of a sintering unit, which leads to an increase in temperature there. Furthermore, the already created molded article parts change physical parameters such as the thermal conductivity in the particle material or also the emissivity of the printed surface. In prior art apparatuses, this repeatedly leads to abortions of the printing process due to uncontrollable process conditions and even damage to the machine.

In the present case, the position of the components in the build area is known. Thus, the sectional view data for the application of the IR acceptor is already available and can be fed to and taken into account by the solver algorithm. The latter is now able to react dynamically to different degrees of filling of the particle material surface. In principle, it is also possible to use this method to automatically place the molded articles in the build area in a process-optimized manner. This eliminates the time-consuming and complex step of manually arranging the molded articles to be generated in the virtual build area. This results in major time and cost savings. For example, there is no need for training in component placement and fine adjustment required to operate sintering machines. In the prior art, in order to ensure optimal orientation and parameterization, molded articles are often created several times, which is known in the art as so-called “ghost jobs”. The elimination of these multiple pre-test prints leads to a significant reduction in manufacturing costs.

In addition, the required repeatability, which is important for industrial production, can be achieved so that tighter tolerances can be applied to the molded articles produced. Thus, an increase in quality is also achieved.

If a larger surface is to be covered, several irradiation unit fields (overlapping fields covered by a group of irradiation units or by different irradiation devices) can easily be staggered. By overlapping the measurement ranges of thermographic cameras and infrared pyrometers, calibration data can further be generated and thus the measurement accuracy of the instruments used can be improved by comparing the measurement data obtained. Thus, almost any build field geometries and sizes are possible without including another complex and cost-intensive design step.

### LIST OF REFERENCE NUMERALS

FIG. H1:

| | |
|---|---|
| H101 | Infrared irradiation unit |
| H102 | Object surface |
| H103 | Temperature of the infrared irradiation units in the X-direction |
| H104 | Resulting temperature distribution on the object surface |
| H105 | Optimal temperature range |
| H106 | Area along the X-direction that is below the optimal temperature |
| H107 | Infrared pyrometer |
| H108 | Infrared irradiation assembly |

FIG. H2:

| | |
|---|---|
| H201 | Infrared irradiation unit |
| H202 | Object surface |
| H203 | Calculated required temperature of the infrared |
| | irradiation units in the X-direction |
| H204 | Resulting temperature distribution on the object surface |
| H205 | Discretization of the required surface temperature and |
| | calculation of the actuating power at the individual |
| | infrared irradiation units |
| H206 | Infrared pyrometer |
| H207 | Thermographic camera |

FIG. H3:

| | |
|---|---|
| H301 | Irradiation assembly |
| H302 | Thermographic camera |
| H303 | Infrared irradiation unit |
| H304 | Temperature sensor |
| H305 | Infrared pyrometer |

FIG. H4:

| | |
|---|---|
| H400 | Irradiation assembly |
| H401- | Infrared irradiation units grouped |
| H406 | into individual heating circuits |

1. A 3D printer comprising:
an irradiation assembly including an array of multiple irradiation units;
a controller;
a build field;
a recoater for applying a particulate material to the build field; and
a print head for selectively applying a liquid to the build field, wherein the print head selectively applies an IR absorbor;
wherein the controller controls the array of multiple irradiation units, each of which is individually controllable with regard to its temperature, or a subset of irradiation units being combined to a group, each group of irradiation units being controllable with regard to its temperature; and
wherein a target temperature on the build field is adjustable by a target temperature setting of each irradiation unit or/and each group of irradiation units in the irradiation assembly;
wherein the irradiation assembly includes:
i) a thermographic camera and/or an infrared pyrometer directed at the build field; and
ii) a thermocouple or resistance thermometer;
wherein the printer is for a high-speed sintering process.

2. The 3D printer of claim 1, wherein the controller is configured to set a target temperature at each irradiation unit or group of irradiation units.

3. The 3D printer of claim 1,
wherein the control of the irradiation units is characterized by one or more features selected from the group consisting of:
the controller is configured to control substantially each irradiation unit or group of irradiation units in the irradiation device to a different target temperature,
the controller comprises a control circuit for target temperature adjustment of each irradiation unit,
the controller comprises a control circuit for target temperature adjustment on the build field,
the controller is configured for using an algorithm to achieve a target temperature on the build field by means of target temperature setting in the irradiation assembly, and
the controller is configured for controlling a subset of the irradiation units combined to a group for achieving the target temperature setting.

4. The 3D printer of claim 1, wherein the irradiation assembly comprises at least one thermographic camera directed at the build field and at least one infrared pyrometer.

5. The 3D printer of claim 4, wherein the thermographic camera is configured for local measurement recordings and the controller is configured for using the infrared pyrometer for calibration of the absolute temperature values.

6. The 3D printer of claim 2,
wherein the control of the irradiation units is characterized by one or more features selected from the group consisting of:
the controller is configured to control substantially each irradiation unit or group of irradiation units in the irradiation device to a different target temperature,
the controller comprises a control circuit for target temperature adjustment of each irradiation unit,
the controller comprises a control circuit for target temperature adjustment on the build field,
the controller is configured for using an algorithm to achieve a target temperature on the build field by means of target temperature setting in the irradiation assembly, and
the controller is configured for controlling a subset of the irradiation units combined to a group for achieving the target temperature setting.

7. The 3D printer of claim 2, wherein the controller is configured to control substantially each irradiation unit or group of irradiation units in the irradiation assembly to a different target temperature.

8. The 3D printer of claim 2, wherein the irradiation assembly comprises a control circuit for target temperature adjustment of each irradiation unit or for target temperature adjustment on the build field.

9. The 3D printer of claim 2, wherein the controller is configured for using an algorithm to achieve a target temperature on the build field by means of target temperature setting in the irradiation assembly.

10. The 3D printer of claim 2, wherein the target temperature setting is achieved by defining irradiation units as a subset of irradiation units combined to a group.

11. The 3D printer of claim 2, wherein the irradiation assembly comprises a control circuit for target temperature adjustment of each irradiation unit or for target temperature adjustment in a defined, partial area on the build field.

12. The 3D printer of claim 6, wherein the irradiation assembly comprises the resistance thermometer.

13. The 3D printer of claim 6, wherein the irradiation assembly includes the infrared pyrometer directed at the build field.

14. The 3D printer of claim 6, wherein the irradiation assembly comprises the infrared pyrometer and the thermographic camera directed at the build field.

15. The 3D printer of claim 14, wherein the thermographic camera is arranged for local measurement recordings and the controller is configured for using the infrared pyrometer for calibration of the absolute temperature values.

16. The 3D printer of claim 1, wherein the irradiation assembly includes more than one thermographic cameras or more than one infrared pyrometers.

17. The 3D printer of claim 1, wherein each irradiation unit includes an infrared energy source, the irradiation assembly includes the thermographic camera, the infrared pyrometer, and the thermocouple.

18. The 3D printer of claim 1, wherein each irradiation unit includes an infrared energy source, the irradiation assembly includes the thermographic camera, the infrared pyrometer, and the resistance thermometer.

19. An irradiation device suitable for a 3D printer, the irradiation device being characterized by being an array of multiple irradiation units, each of which is individually controllable with regard to its temperature, or a subset of irradiation units being combined to a group, each group of irradiation units being controllable with regard to its temperature.

20. A method for producing a molding by means of particle material deposition and selective solidification, said method using an irradiation device according to claim 1, wherein each irradiation unit is individually controllable with regard to its temperature, or a subset of irradiation units is combined to a group, each group of irradiation units being controllable with regard to its temperature;
wherein the method includes selectively applying a liquid to a build field.
